(19) United States
(12) Patent Application Publication
(10) Pub. No.: US 2021/0319452 A1
(43) Pub. Date: Oct. 14, 2021

(54) INTELLIGENT PAYMENT USING AUGMENTED REALITY

(71) Applicant: Wells Fargo Bank, N.A., San Francisco, CA (US)

(72) Inventors: Ramanathan Ramanathan, Bellevue, WA (US); Prabal Nandi, Hyderabad (IN)

(21) Appl. No.: 15/708,737

(22) Filed: Sep. 19, 2017

(51) Int. Cl. G06Q 20/40; G06Q 20/38

(52) U.S. Cl. CPC G06Q 20/40145; G06Q 20/385

(57) ABSTRACT

The innovation disclosed and claimed herein, in one aspect thereof, comprises systems and methods of intelligent payment using augmented reality. The system and method of the innovation can include an augmented reality device and a payment service provider. The augmented reality device can include a monitoring component that monitors actions of a payer and a recording component that collects context data and environment data of the actions. The recording component can also collect biometric data to verify the identity of a payee. The recording component can receive a voice code from the payer to authorize a transaction. The payment service provider can include a determination component that determines a potential transaction from the context data and environment data; and a transfer component that completes a transaction between the payer and a payee.

### BACKGROUND

Computer systems and networks can facilitate the tasks of payments in retail and other marketplaces. For example, a consumer can pay for an item from either an online merchant or at a restaurant or at a point of sale of a brick-and-mortar store through the use of a payment provider that can be accessed on his or her smart phone, tablet, laptop computer, desktop computer, or other personal mobile or desktop device. Users of a payment provider can use the payment provider website or a payment provider application or “app” on a mobile device to make payments to various online or offline merchants.

Augmented reality systems such as augmented reality applications on mobile phones commonly use a device display to present a user with the location or a review of a business near the user, sometimes overlaid on an image of the user's surroundings captured by a camera in the phone. These systems can help a user to make payment to services, retail or market place based on the information overlaid on a real-time image of the business in the mobile phone. However, the users must still provide information related to payment by entering required information in the website or app to process the payment.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of intelligent payment using augmented reality. A system of the innovation can include an augmented reality device and a payment service provider. The augmented reality device can include a monitoring component that monitors actions of a payer and a recording component that collects context data and environment data of the actions. The recording component can receive a voice code from the payer to authorize the transaction. The payment service provider can include a determination component that determines a potential transaction from the context data and environment data; and a transfer component that completes a transaction between the payer and a payee.

A method of the innovation can include monitoring actions of a payer and determining context data and environment data of the actions. A potential transaction is determined from the context data and environment data. A voice code is received from the payer to authorize the transaction between the payer and the payee and a transaction is completed between the payer and a payee.

A computer readable medium having instructions to control one or more processors configured to monitor actions of a payer and capture an image of a website being operated by the payer. The computer readable medium can determine a potential transaction from the website and receive a voice code authorization of the potential transaction from the payer. The computer readable medium then completes a transaction between the payer and the website.

In aspects, the subject innovation provides substantial benefits in terms of facilitating payment between a payer and a payee. One advantage resides in a more automated payment transfer using augmented reality. Another advantage resides in the lack of need for a physical payment method carried by a user.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a system for intelligent payment using augmented reality.

FIG. 2 illustrates an example component diagram of an augmented reality device.

FIG. 3 illustrates an example component diagram of a payment service provider.

FIG. 4 a method for intelligent payment using augmented reality.

FIG. 5 illustrates a computer-readable medium or computer-readable device comprising processor-executable instructions configured to embody one or more of the provisions set forth herein, according to some embodiments.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

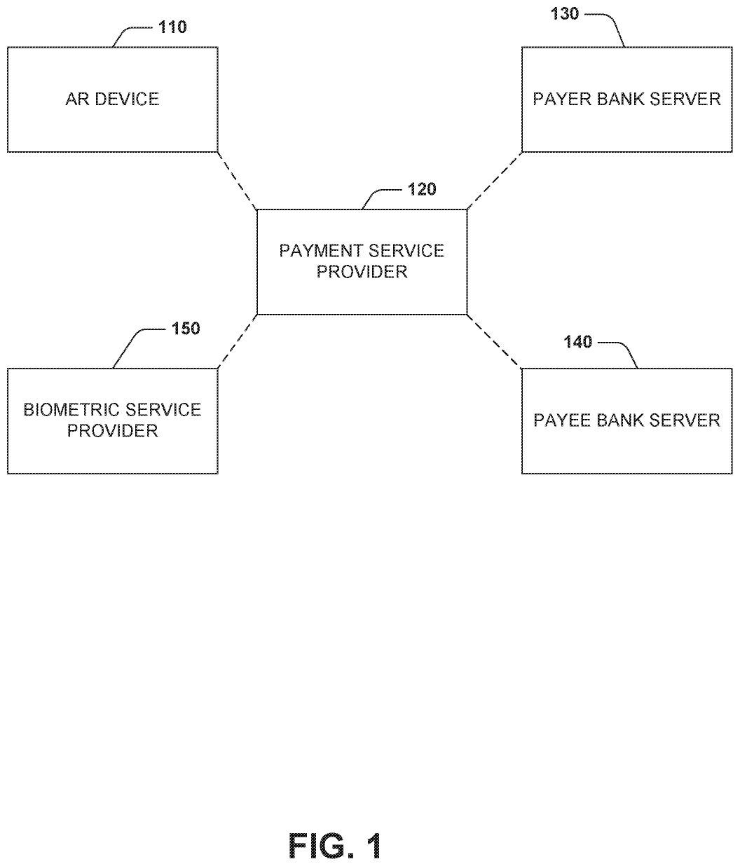

FIG. 1 illustrates an example component diagram of a system 100 for intelligent payment using augmented reality. The system 100 includes an augmented reality (AR) device 110. The AR device 110 continuously monitors and/or records the conversations and/or interactions of a payer. A payer is a person associated with the AR device 110 such that the payer can make transactions or payments from their bank account, credit card, debit card, mobile wallet, and/or the like.

The AR device 110 can capture images and audio while monitoring the actions of the payer. For example, the AR device 110 can capture one or more images of the inputs associated with a payee. The AR device 110 collects context data such as voice signals exchanged during a conversation or interaction between the payer and the payee. The AR device 110 can collect environment data such as location name, GPS coordinates, and/or the like. In some embodiments, the AR device 110 can employ a Natural Language Generation/Natural Language Processing (NLG/NLP) to process voice-input signals and generating voice-output signals.

The AR device 110 can provide the context data and environment data collected about the actions of the payer to a payment service provider 120. The payment service provider 120 facilitates transactions between the payer and the payee. In some embodiments, the payment service provider 120 determines whether a transaction is to be completed from the provided data.

In some embodiments, the AR device 110 detects a voice code said by the payer which initiates or authorizes a transaction to be completed by the payment service provider 120. The AR device 110 may generate a unique payment identifier code (UPIC) and send the UPIC to the payment service provider 120. The UPIC includes a public key, contact information of the payee, and a unique identifier of the payee.

The payment service provider 120 receives the payment request with UPIC, derives the public key and forwards the public key, payment amount and payee details like bank account, merchant details and/or the like to a payer bank server 130. The payer bank server 130 interacts with a payee bank server 140 to complete the transaction. The payer bank server 120 and/or the payee bank server 130 confirms the completion of the transaction to the payment service provider 120. The payment service provider 120 can forward the payment confirmation to the AR device 110.

In some embodiments, the AR device 110 may include one or more biometric sensors to record biometric parameters associated with a payer and/or payee such as an individual person. The AR device 110 can send the biometric parameters to a biometric service provider 150. In some embodiments, the biometric service provider 150 may be an external server maintained by a government entity. The biometric service provider 150 can store details of citizens of a country such as biometric data, social security numbers, bank account information and/or the like. In other embodiments, the biometric service provider is integrated within the payment service provider 120 as described in further detail below.

The biometric service provider 150 receives biometric data from the AR device 110 such as a facial scan, gait analysis data, voice data, iris data, fingerprint data, and/or the like. The biometric service provider 150 can match the biometric data to stored biometric data to determine or confirm the identity of the payee and/or payer. In some embodiments, the biometric service provider 150 continuously verifies identities of payees as the payer encounters the payees. In other embodiments, the biometric service provider 150 verifies the identities of payees upon the AR device 110 receiving a voice code to complete a payment.

In one example of the system in operation, the AR device 110 captures one or more images of inputs associated with the payee. The captured image may be a facial image of the payee, image of a receipt, a shopping cart, or an advertisement. The AR device 110 collects context data such as voice signals exchanged during interaction between the payer and the payee, and environment data associated with the payer and payee. For example, the context data may be “I would like to pay $300 to Walmart restaurant. Let me know about the tip . . . ok, then I will pay $350.” The AR device 110 transmits the captured images and recorded data to the payment service provider 120. The payment service provider 120 verifies the authenticity of the AR device 110 based on a unique AR device ID provided to the AR device 110 during a previous registration process. The AR device 110 can be a registered device to communicate with the payment service provider 120.

Upon verification, the payment service provider 120 forwards the captured images to the biometric service provider 150. The biometric service provider 150 receives the captured images of the inputs associated with payee for example, facial image of the payee and performs facial recognition to authenticate the payee and retrieve details of identified payee such as bank information. In some embodiments, the AR device 110 may comprise one or more biometric sensors and the biometric service provider 150 receives biometric parameters associated with payee (for instance, individual person), and processes the received biometric parameters to verify the payee. The biometric parameters may include one or more physiological metrics such as pulse rate, blood pressure, body temperature, and psychological parameters associated with the payee. In the embodiment that the captured image is a bill or receipt, the biometric service provider 150 can search, retrieve, and process a quick response (QR) code from the bill receipt image to verify that the payee is an authorized entity. Upon verification, the biometric service provider 150 generates a unique payment identification code (UPIC) comprising public key, primary/verified contact number of the payee, and unique identification of the payee concatenated together. The biometric service provider 150 sends the UPIC to the payment service provider 120 which is forwarded to the AR device 110.

In some embodiments, the AR device 110 prompts for and records a predetermined voice code, for example “LET'S PAY.” The AR device 110 determines that the payment must be made to the payee and sends a payment request to the payment service provider 120 along with the UPIC. The payment service provider 120 receives the payment request with the UPIC, derives the public key and forwards the public key, payment amount and payee details like bank account, merchant details and the like to the payer bank server 130. The payer bank server 130 interacts with the payee bank server 140 to complete the transaction and confirms the completion of the transaction to the payment service provider 120. The payment service provider 120 forwards the payment confirmation to the AR device 110.

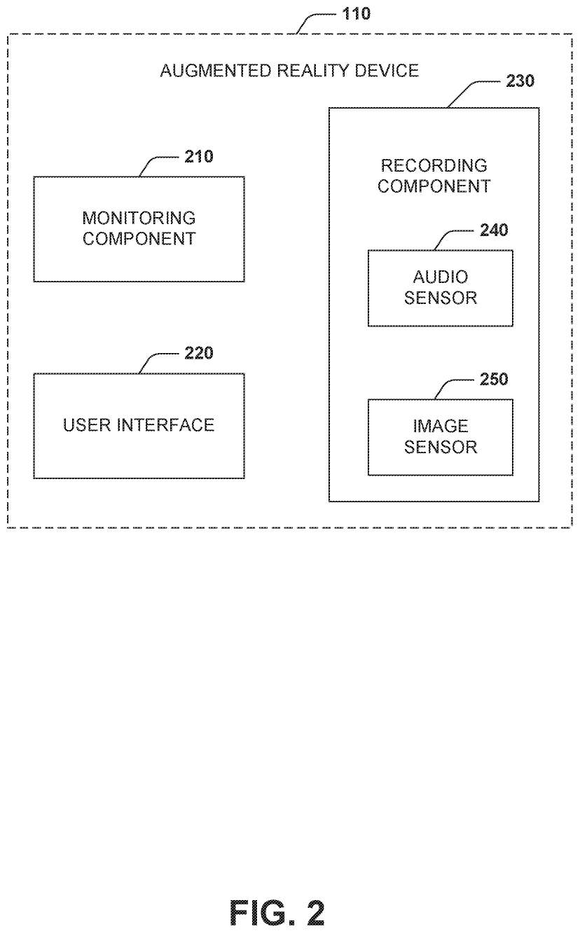

FIG. 2 illustrates a detailed component diagram of the AR device 110. The AR device 110 includes a monitoring component 210 that continuously monitors and/or records the actions of a payer. For example, the monitoring component 210 can determine when the payer is in motion or standing still. For example, the monitoring component 210 can include a gyroscope or gyroscope data to determine motion. The monitoring component 210 can determine whether the payer is conversing with a person or machine. In some embodiments, the monitoring component 210 determines the location of the payer. For example, the monitoring component 210 can use GPS, Wi-Fi, location data, and/or the like to determine whether the payer is in a place of commerce such as a restaurant or store.

The AR device 110 includes a user interface 220 that provides an augmented reality environment to the payer. The user interface 220 can overlay information and/or data on a heads-up display for the payer to view. For example, the user interface 220 can provide identity information for potential payees in the field of view of the AR device 110 such that the payer can view the information in the same augmented reality view to facilitate the payer in completing a transaction. The user interface 220 can also provide the payer's bank account balance, credit card selection, and/or the like for the payer to view and/or confirm.

The AR device 110 includes a recording component 230 to capture images and audio of the actions of the payer. For example, the AR device 110 can capture one or more images of the inputs associated with a payee. The recording component 230 collects context data such as voice signals exchanged during a conversation or interaction between the payer and the payee. The recording component 230 includes an audio sensor 240 and an image sensor 250. The audio sensor 240 records audio data of the conversations and/or environment audio of the payer. The image sensor 250 can capture still images and/or video of the environment around the payer.

In some embodiments, the AR device 110 is a wearable device. The image sensor 240 can scan the environment of the payer for a bill or check. For example, a payer orders food at a restaurant and receives a bill at the end of the meal. The image sensor 240 can capture an image of the bill. The AR device 110 may process the image using NLP algorithms to determine the payee (the restaurant), transaction amount, and other transaction details.

In other embodiments, the recording component 230 can capture biometric data of a payee. The biometric data can be audio, video, image, fingerprint, and/or like to facilitate identifying a payee. The biometric data is provided by the AR device 110 to the payment service provider 120 and/or the biometric service provider 150.

In some embodiments, the recording component 230, the audio sensor 240, and/or the monitoring component 210 can listen for a voice code that triggers completion of a transaction between the payer and the payee. Once the voice code is detected, a transaction can be completed using the payment service provider 120. The voice code audio may be authenticated as the payer's voice. For example, the recording component 230 hears “I want to pay fifty dollars to Payee.” The audio can be processed by the recording component 230 using NLP to determine the voice code has been spoken and the voice code is authenticated as the payer's voice.

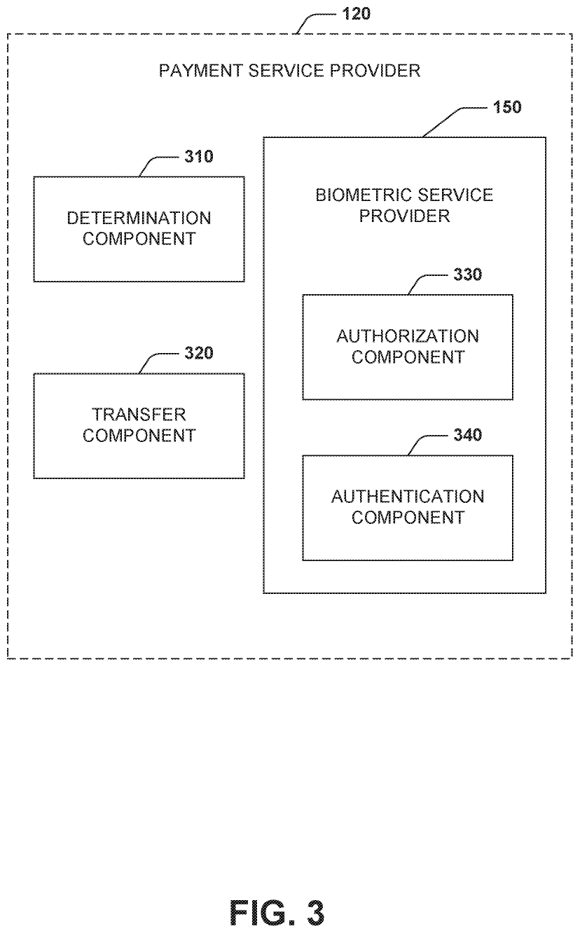

FIG. 3 illustrates a component diagram of a payment service provider 120. The payment service provider 120 includes a determination component 310 that determines a potential transaction from the context data and environment data. For example, the determination component 310 receives a voice code (or voice data) from the AR device 110 which indicates a potential transaction. In another example, the determination component 310 receives an image of a bill which indicates a potential transaction.

In some embodiments, the determination component 310 receives the context data and environment data and determines that a potential transaction exists. The context data can be data such as time of day (e.g. meal time). The environment data can be data such as location (e.g. at a restaurant). The determination component 310 determines that a potential transaction is likely to take place and prepares to listen for a voice code. In another embodiment, the determination component 310 can prompt a payer with the potential transaction details and to provide a voice code to confirm the transaction.

The payment service provider 120 includes a transfer component 320 that completes a transaction between the payer and a payee. The transfer component 320 receives the identity of the payee. The transfer component 320 can determine the bank information for the payee. In some embodiments, the transfer component 320 also retrieves payer bank information. The transfer component 320 can send the payment request having transaction details to the payer bank server 130. The transfer component 320 receives the payment request with the UPIC, derives the public key and forwards the public key, payment amount and payee details like bank account, merchant details and/or the like to a payer bank server 130. The payer bank server 130 interacts with the payee bank server 140 to complete the transaction. The transfer component 320 can receive confirmation of completion of the transaction from the payer bank server 120 and/or the payee bank server 130. The transfer component 320 can forward the payment confirmation to the AR device 110.

In some embodiments, the biometric service provider 150 is integrated into the payment service provider 120. For purposes of showing the integrated embodiment, the biometric service provider 150 is depicted in FIG. 3 as within the payment service provider 120. However, it is appreciated that the biometric service provider 150 may be a separate component that is communicatively connected to the payment service provider 120.

The biometric service provider 150 includes an authorization component 330. The authorization component 330 authorizes the transfer component 320 to complete the transaction based on the payment request received from the AR device 110. In some embodiments, the authorization component 330 receives a voice code spoken by the payer from the AR device 110. The authorization component 330 can perform NLP on the voice code to determine the words spoken by the AR device 110. The authorization component 330 compares the words to a stored voice code to determine a match. If the words match, the authorization component 330 permits the transaction to be completed. In some embodiments, the authorization component 330 can use an authentication component 340 to authenticate the voice speaking the voice code as the payer's voice before permitting the transaction. The authentication component 340 can match the voice of the voice code to a stored previously spoken voice code registered by the payer.

In some embodiments, the authentication component 330 can further authenticate a payee. The biometric service provider 150 can match the biometric data to stored biometric data to determine or confirm the identity of the payee and/or payer. In some embodiments, the biometric service provider 150 continuously verifies identities of different potential payees as the payer encounters the payees. In other embodiments, the biometric service provider 150 verifies the identities of payees upon the AR device 110 receiving a voice code to complete a payment.

In one example, the payee is an online merchant for online shopping or an advertisement image displayed through a website on a computer. The image sensor 250 captures the image of the website or advertisement image and forwards the captured image to the payment service provider 120. The payment service provider 230 processes the captured image and sends a request for a token to the online merchant cloud i.e., online merchant's server. The merchant cloud/server issues a token/notification to the payment service provider 120 and the payment service provider 120 sends the token/notification to the AR device 110. The user interface 220 notifies the payer about the payment request and requests authorization from the payer. Upon receiving authorization (e.g. a voice code authorization) from the payer, the AR device 110 sends an authorization message to the payment service provider 120 to proceed with a transfer from the payee to the online merchant, i.e. payee. The payment service provider 120 and/or the transfer component 320 interact with the merchant cloud/server, i.e. payee bank server 140 and process the transfer.

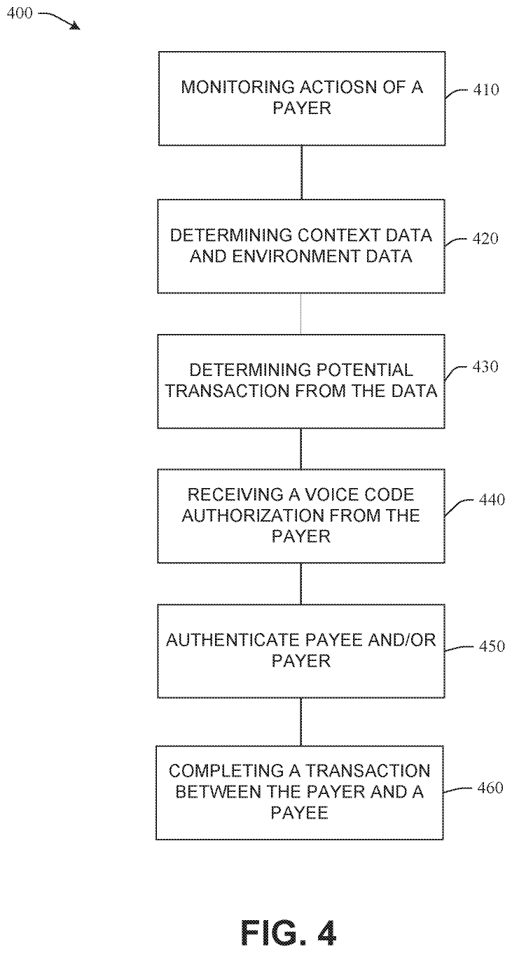

With reference to FIG. 4, example methods 400 are depicted for authenticating a user to verify identity. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 are described in conjunction with a specific example is for explanation purposes.

FIG. 4 illustrates a method 400 for facilitating transactions for a payer. At 410, actions and/or interactions of a payer is monitored. For example, a payer has registered an AR device such that it is associated with the payer and the AR device is carried, worn, or otherwise in the area of the payer. The AR device monitors the environment around the payer for potential transactions and/or a voice code to initiate and complete a transaction. At 420, context data and/or environment data of the actions are determined. At 430, a potential transaction from the context data and environment data is determined. In the example, the AR device monitors a conversation of the payer with a payee at a store. The environment data may be determined as the payer location being at a store where a transaction typically occurs. The context data may be capturing an image of a price tag or UPC bar code to determine price of goods. The AR device can determine the potential transaction details from the context data and the payee from the environment data.

At 440, a voice code is received by the AR device to authorize the transaction from the payer to the payee. In the example, the voice code spoken by the payer such as “I want to pay 30 dollars to the payee.” or “Let's pay.” At 450, the payee and/or the payee may be authenticated. The authentication can be done using biometric algorithms to confirm an identity of the payee. In the example, the AR device can capture an image of a payee's face. Facial recognition biometric algorithms can be employed to confirm the payee's identity. In some embodiments, the payee is a cashier for a store and the payee's facial recognition data is associated with the store. At 460, the transaction between the payer and the payee is completed. The transaction can be completed by transferring the money from the payer's bank to the payee's bank. In some embodiments, alerts are generated upon completion of the transfer and can be sent to the payer and/or payee.

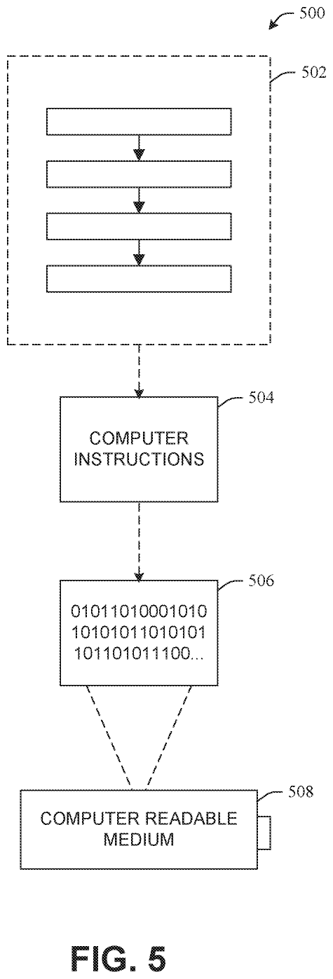

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 5, wherein an implementation 500 comprises a computer-readable medium 508, such as a CD-R, DVD-R, flash drive, a platter of a hard disk drive, etc., on which is encoded computer-readable data 506. This computer-readable data 506, such as binary data comprising a plurality of zero's and one's as shown in 506, in turn comprises a set of computer instructions 504 configured to operate according to one or more of the principles set forth herein. In one such embodiment 500, the processor-executable computer instructions 504 is configured to perform a method 502, such as at least a portion of one or more of the methods described in connection with embodiments disclosed herein. In another embodiment, the processor-executable instructions 504 are configured to implement a system, such as at least a portion of one or more of the systems described in connection with embodiments disclosed herein. Many such computer-readable media can be devised by those of ordinary skill in the art that are configured to operate in accordance with the techniques presented herein.

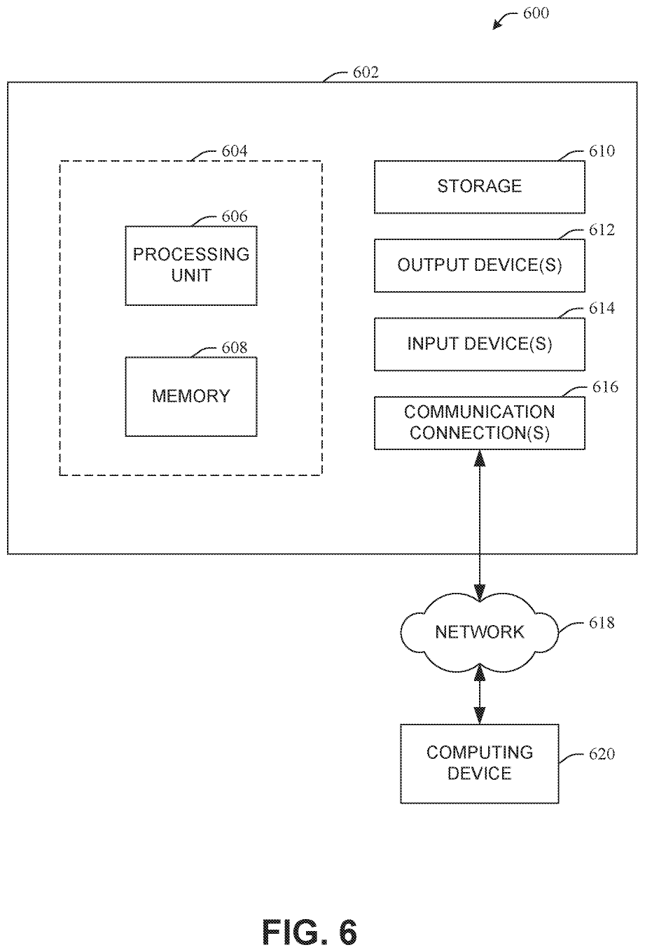

With reference to FIG. 6 and the following discussion provide a description of a suitable computing environment in which embodiments of one or more of the provisions set forth herein can be implemented. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 6 illustrates a system 600 comprising a computing device 602 configured to implement one or more embodiments provided herein. In one configuration, computing device 602 can include at least one processing unit 606 and memory 608. Depending on the exact configuration and type of computing device, memory 608 may be volatile, such as RAM, non-volatile, such as ROM, flash memory, etc., or some combination of the two. This configuration is illustrated in FIG. 6 by dashed line 604.

In these or other embodiments, device 602 can include additional features or functionality. For example, device 602 can also include additional storage such as removable storage or non-removable storage, including, but not limited to, magnetic storage, optical storage, and the like. Such additional storage is illustrated in FIG. 6 by storage 610. In some embodiments, computer readable instructions to implement one or more embodiments provided herein are in storage 610. Storage 610 can also store other computer readable instructions to implement an operating system, an application program, and the like. Computer readable instructions can be accessed in memory 608 for execution by processing unit 606, for example.

The term “computer readable media” as used herein includes computer storage media. Computer storage media includes volatile and nonvolatile, non-transitory, removable and non-removable media implemented in any method or technology for storage of information such as computer readable instructions or other data. Memory 608 and storage 610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 602. Any such computer storage media can be part of device 602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 602 can include one or more input devices 614 such as keyboard, mouse, pen, voice input device, touch input device, infrared cameras, video input devices, or any other input device. One or more output devices 612 such as one or more displays, speakers, printers, or any other output device can also be included in device 602. The one or more input devices 614 and/or one or more output devices 612 can be connected to device 602 via a wired connection, wireless connection, or any combination thereof. In some embodiments, one or more input devices or output devices from another computing device can be used as input device(s) 614 or output device(s) 612 for computing device 602. Device 602 can also include one or more communication connections 616 that can facilitate communications with one or more other devices 620 by means of a communications network 618, which can be wired, wireless, or any combination thereof, and can include ad hoc networks, intranets, the Internet, or substantially any other communications network that can allow device 602 to communicate with at least one other computing device 620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method, comprising:
generating and displaying an augmented reality user interface on an augmented reality device, wherein the augmented reality user interface renders a heads up display within the augmented reality device that concurrently displays a payer's surrounding area and the heads up display displaying transaction options, wherein the augmented reality user interface dynamically changes in real time according to movement of the augmented reality device;
recording actions of the payer by the augmented reality device, wherein the actions include encountering one or more potential payees;
displaying the one or more potential payees in the augmented reality user interface on the augmented reality device;
updating the augmented reality interface in real time on the augmented reality device based on the encountering the one or more potential payees;
continuously verifying identities of the one or more potential payees for the duration of the encounter, wherein the continuous verifying comprises:
continuously recording biometric information of the payer and the selected payee; and
continuously matching the biometric information with previously collected biometric information for the duration of the encounter;
updating the display, in real time, of the continuous match in the augmented reality user interface on the augmented reality device;
determining, by the augmented reality device, context data and environment data of the actions;
determining, by a payment service provider, a potential transaction from the context data and environment data; and
completing, by the payment service provider, a transaction between the payer and a selected payee based on the determination of the potential transaction.

2. The method of claim 1, comprising:
receiving a voice code from the payer to authorize the transaction between the payer and the selected payee.

3. The method of claim 2, wherein the voice code is pre-selected during a registration of the payer.

4. The method of claim 1, comprising:
authenticating the payer and the selected payee.

5. (canceled)

6. The method of claim 1, wherein the biometric information of the selected payee is a facial recognition image data and the authenticating is continuously matching the facial recognition image data to a previously captured image of the payee for the duration of the encounter.

7. The method of claim 1, wherein the biometric information of the payer is a voice recognition data and the authenticating is continuously matching the voice recognition data to a previously captured voice of the payer for the duration of the encounter.

8. The method of claim 1, comprising:
generating a unique payment identification code for the transaction, wherein the unique payment identification code includes a public key, contact information of the selected payee, and a unique identifier of the selected payee.

9. (canceled)

10. A system, comprising:
an augmented reality device comprising:
a user interface that generates and renders an augmented reality user interface on an augmented reality device, wherein the augmented reality user interface renders a heads up display within the augmented reality device that concurrently displays a payer's surrounding area and the heads up display displaying transaction options, wherein the augmented reality user interface dynamically changes in real time according to movement of the augmented reality device;
a monitoring component that records actions of the payer, wherein the actions include encountering one or more potential payees;
the augmented reality user interface that:
displays the one or more potential payees in the augmented reality user interface on the augmented reality device and
updates in real time on the augmented reality user device based on the encountering the one or more potential payees; and
a recording component that collects context data and environment data of the actions; and
a payment service provider comprising:
an authentication component that continuously authenticates the payer and the payee for the duration of the encounter while completing a transaction, the authentication comprising:
the recording component continuously records biometric information of the payer and the payee; and
the authentication component continuously matches the biometric information with previously collected biometric information for the duration of the encounter;
the augmented reality user interface updates the display, in real time, of the continuous match in the augmented reality user interface on the augmented reality device;
a determination component that determines a potential transaction from the context data and environment data; and
a transfer component that completes a transaction between the payer and a payee.

11. The system of claim 10, wherein the payment service provider comprises:
an authorization component that receives a voice code from the payer to authorize the transaction between the payer and the payee.

12. The system of claim 11, wherein the voice code is pre-selected during a registration of the payer.

13. (canceled)

14. (canceled)

15. The system of claim 10, wherein the biometric information of the payee is a facial recognition image data and the authenticating is continuously matching the facial recognition data to a previously captured image of the payee for the duration of the encounter.

16. The system of claim 10, wherein the biometric information of the payer is a voice recognition data and the authenticating is continuously matching the voice recognition data to a previously captured voice of the payer for the duration of the encounter.

17. The system of claim 10, comprising:
wherein the payment service provider generates a unique payment identification code for the transaction, wherein the unique payment identification code includes a public key, contact information of the payee, and a unique identifier of the payee.

18. (canceled)

19. A non-transitory computer readable medium having instructions to control one or more processors configured to:
generate and display an augmented reality user interface on an augmented reality device, wherein the augmented reality user interface renders a heads up display within the augmented reality device that concurrently displays a payer's surrounding area and the heads up display displaying transaction options, wherein the augmented reality user interface dynamically changes in real time according to changes in the payer's surrounding area;
record actions of the payer by the augmented reality device, wherein the actions include encountering one or more potential websites;
display, on the augmented reality device, the one or more potential websites in the augmented reality user interface;
update the one or more potential websites in real time on the augmented reality user interface based on the encountering;
capture an image of a website being operated by the payer by the augmented reality device;
determine a potential transaction from the website based on the captured image;
continuously verify the website while conducting a potential transaction for the duration being operated by the payer;
display, in real time, the continuous verification in the augmented reality user interface on the augmented reality device;
receive a voice code authorization of the potential transaction from the payer; and
complete a transaction between the payer and the website based on the authorization and the verification.

20. The computer readable medium of claim 19, wherein the one or more processors are further configured to:
complete the transaction from a payer bank server to a merchant cloud server associated with the website.
